(19) United States
(12) Patent Application Publication
(10) Pub. No.: US 2016/0328858 A1
(43) Pub. Date: Nov. 10, 2016

(54) IMAGE PROCESSING SYSTEM, IMAGE PROCESSING METHOD, AND IMAGE PROCESSING PROGRAM

(71) Applicant: Kabushiki Kaisha Toshiba, Tokyo (JP)

(72) Inventors: Kenji Kimiyama, Kawasaki (JP); Toshio Sato, Yokohama (JP); Kentaro Yokoi, Tokyo (JP); Yoshihiko Suzuki, Tokyo (JP)

(21) Appl. No.: 15/216,306

(22) Filed: Jul. 21, 2016

Related U.S. Application Data
(63) Continuation of application No. PCT/JP2014/064727, filed on Jun. 3, 2014.

(30) Foreign Application Priority Data
Jan. 24, 2014 (JP) 2014-011624

(51) Int. Cl. G06T 7/20; G06T 5/00

(52) U.S. Cl. CPC G06T 7/20; G06T 5/002; G06T 2207/10004

(57) ABSTRACT

An image processing system of an embodiment includes a first analyzer, an image processor, and a first scaler. The first analyzer is configured to analyze image data to generate an analysis result. The image processor is configured to perform image processing of the image data in accordance with the analysis result, to generate processed image data. The image processor includes a first image processor and a second image processor. The second image processor is configured to receive an output from the first image processor. The first scaler configured to determine whether the analysis result is usable with respect to the image data to be used by the second image processor after the first image processor performs the image processing, and to scale the analysis result to be used by the second image processor when the analysis result is not usable with respect to the image data to be used by the second image processor.

### CROSS-REFERENCE TO RELATED APPLICATIONS

This application is based upon and claims the benefit of priority from Japanese Patent Application No. 2014-011624, filed on Jan. 24, 2014 and International Patent Application No. PCT/JP2014/064727, filed on Jun. 3, 2014; the entire contents of which are incorporated herein by reference.

### FIELD

Embodiments described herein relate generally to an image processing system, an image processing method, and an image processing program.

### BACKGROUND

In improving the image quality of video that has deteriorated in an image processing system, there are generally various video quality deterioration modes, and it is necessary to select a plurality of image quality improvement methods, depending upon the condition of the source video. Types of deterioration include blurring (loss of sharpness), random noise, camera shake, color balance problems, pulse noise, and line noise. When the original image capture is onto film, there are also film grain noise, scratch noise, dust noise, and color fading. Image quality improvement methods to handle these types of deterioration have been developed separately. Effective method are sharpening for blurring, noise removal filtering for random noise and grain noise, camera shake correction for camera shake, and color balance correction for color balance problems and color fading. For pulse noise, line noise, scratch noise, and dust noise, dedicated noise detection and noise reduction processing for each is effective. For deterioration that occurring in combinations, processing is done by combining a plurality of these image quality improvement processing techniques. An operator verifies, for example, the deteriorated condition, selects the required image improvement processing, determines the processing sequence, sets parameters (threshold for detection of deterioration and processing accuracy) and executes the processing. For this reason, in an image processing system, there have been problems in improving the efficiency of the constitution, such as the effective use of hardware resources when combining a plurality of processing techniques, shortening of processing time, and flexible changing of the processing sequence.

### BRIEF DESCRIPTION OF THE DRAWINGS

FIG. 1 is a block diagram showing an image processing system of a first embodiment.

FIG. 2 is a block diagram showing an image processing system of a second embodiment.

FIG. 3 is a block diagram showing an image processing system of a third embodiment.

FIG. 4 is a block diagram showing a reference constitution of an image processing system.

FIG. 5 is a block diagram showing another reference constitution of an image processing system.

FIG. 6 describes a variation example and the like of the first and second embodiments.

FIG. 7 describes another variation example and the like of the first and second embodiment.

FIG. 8 describes yet another variation example and the like of the first and second embodiment.

### DETAILED DESCRIPTION

Some embodiments provide an image processing system, an image processing method, and an image processing program capable of improving the efficiency of the constitution when combining a plurality of image processing techniques.

An image processing system of an embodiment includes a first analyzer, an image processor, and a first scaler. The first analyzer is configured to analyze image data to generate an analysis result. The image processor is configured to perform image processing of the image data in accordance with the analysis result, to generate processed image data. The image processor includes a first image processor and a second image processor. The second image processor is configured to receive an output from the first image processor. The first scaler configured to determine whether the analysis result is usable with respect to the image data to be used by the second image processor after the first image processor performs the image processing, and to scale the analysis result to be used by the second image processor when the analysis result is not usable with respect to the image data to be used by the second image processor.

Image processing systems of embodiments are described below.

### First Embodiment

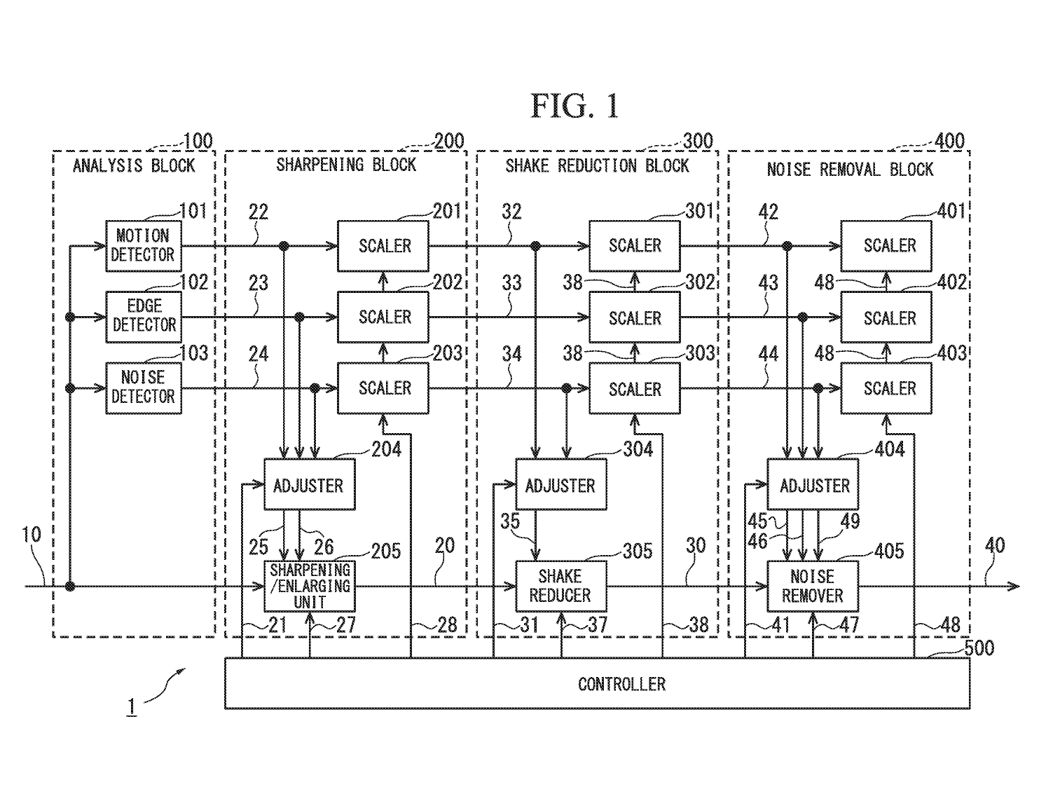

FIG. 1 is a block diagram showing an example of the constitution of an image processing system 1 of the first embodiment. The image processing system 1 shown in FIG. 1 includes an analysis block 100, a sharpening block 200, a shake compensation block 300, a noise removal block 400, and a controller 500. The image processing system 1, for example, can be constituted by a processor such as an image processing DSP (digital signal processor) or a general-purpose CPU (central processing unit) and a program that the processor executes, an image processing ASIC (application-specific integrated circuit), an FPGA (field-programmable gate array), and an image processing IP (intellectual property) core or the like. Each block shown in FIG. 1, for example, can be constituted as one module. The analysis block 100 includes a motion detector 101, an edge detector 102, and a noise detector 103. Each of the sharpening block 200, the shake reduction block 300, and the noise removal block 400 performs image processing, which is a prescribed image quality improvement processing, of the input video, and outputs the processed video. The sharpening block 200 includes scalers 201, 202, and 203, an adjuster 204, and a sharpening/enlarging unit 205. The shake reduction block 300 includes scalers 301, 302, and 303, an adjuster 304, and a shake reducer 305. The noise removal block 400 includes scalers 401, 402, and 403, an adjuster 404, and a noise remover 405.

The motion detector 101 receives image data 10, which is the source video, performs motion detection based on, for example, a plurality of frames of the image data 10, and outputs a motion vector 22 that represents the detection results. The motion detector 101 outputs the motion vector 22 to the scaler 201 and the adjuster 204. In this case, the motion vector 22 is a type of analysis result with respect to the image data 10, and is data that includes value information for representing a plurality of motion vectors.

The edge detector 102 receives the image data 10, which is the source video, performs edge detection from the image data 10, and outputs an edge image 23 representing the detection result by pixel values. The edge detector 102 outputs the edge image 23 to the scaler 202 and the adjuster 204.

The noise detector 103 receives the image data 10, which is the source video, detects noise from the image data 10, and outputs a noise detection result 24 representing the detection result. The noise detector 103 outputs the noise detection result 24 to the scaler 203 and the adjuster 204. The noise detection result 24 is represented by information representing, for example, the noise level, position, and type. The method of creating the noise detection result 24 as information is dependent upon the image quality improvement processing that is to be done. In the case of random noise and grain noise, the noise detection result 24 includes information representing the noise level. In the case of scratch noise and line noise, the noise detection result 24 includes information representing the starting and ending coordinates of a line segment. In the case of pulse noise and dust noise, the noise detection result 24 includes information representing position and size.

Although, in FIG. 1 the analysis block 100 has three types of analysis functions, the constitution within the analysis block 100 is not restricted to this combination.

In the sharpening block 200, the sharpening/enlarging unit 205 receives the image data 10, which is the source video, and inputs, via the adjuster 204, as the motion vector 25, the motion vector 22 output by the motion detector 101. The sharpening/enlarging unit 205 also inputs as the edge image 26, via the adjuster 204, the edge image 23 output by the edge detector 102. The sharpening/enlarging unit 205, in accordance with the motion vector 25 and the edge image 26, performs image processing to restore the detailed parts of and enlarge the image data 10. The sharpening/enlarging unit 205 outputs image data 20, which represents an image that is the received image data 10 after restoration of detailed parts and enlargement. Because of the enlargement processing, the output image data 20 has a resolution that is different from the resolution of the image data 10.

In the sharpening/enlarging unit 205, for example, a super-resolution algorithm is used. When performing sharpening and enlargement processing, the sharpening/enlarging unit 205 uses the information of the previous and subsequent frames that are position-adjusted by the motion vector 25. The sharpening and enlargement processing in the present embodiment uses the art of the super-resolution algorithm. The sharpening/enlarging unit 205 uses the edge image 26 to remove the flat parts that do not require sharpening from the object being processed. The sharpening/enlarging unit 205 is controlled by a control signal 27 output by the controller 500.

The adjuster 204 receives the motion vector 22, the edge image 23, and the noise detection result 24, performs prescribed adjustment processing in accordance with the image processing to be performed by the sharpening/enlarging unit 205, and outputs a motion vector 25 and the edge image 26. Because the sharpening block 200 is the first image processing block, the motion vector 22, the edge image 23, and the noise detection result 24, which are the analysis results output from the analysis block 100, are input as is to the adjuster 204. The adjuster 204, for example, can perform adjustment processing using the noise detection result 24, so that a part of a motion vector 22 or an edge image 23 that would have low reliability if used as is in the image processing by the sharpening/enlargement unit 205 is not used. The adjuster 204, using the noise detection result 24, generates the motion vector 25 and the edge image 26, in which a part of the motion vector 22 and the edge image 23 have been made invalid, and outputs these to the sharpening/enlarging unit 205. That is, in this case, the output of the adjuster 204 is the motion vector 25 and the edge image 26 from which, for example, the influence of noise has been excluded. The adjuster 204 can receive from the controller 500 information known at the time of image capture and can adjust the analysis results, that is, the motion vector 22 and the edge image 23, in accordance with the image processing by the sharpening/enlarging unit 205. The information known at the time of image capture is, for example, information such as the specifications of the lens and the imaging element of the imaging apparatus and the image capturing conditions. The adjuster 204 is controlled by a control signal 21 output by the controller 500.

The scaler 201, in accordance with the result of image processing by the sharpening/enlarging unit 205, scales the motion vector 22 and outputs it as a motion vector 32. The scaler 201 outputs the motion vector 32 to the scaler 301 and the adjuster 304. The scaler 202, in accordance with the result of the image processing by the sharpening/enlarging unit 205, scales the edge image 23 and outputs it as an edge image 33. The scaler 202 outputs the edge image 33 to the scaler 302. The scaler 203, in accordance with the result of the image processing by the sharpening/enlarging unit 205 scales the noise detection result 24 and outputs it as a noise detection result 34. The scaler 203 outputs the noise detection result 34 to the scaler 303 and the adjuster 304. The scalers 201, 202, and 203 scale the motion vector 32, the edge image 33, and the noise detection result 34, in accordance with the extent that the resolution of the image data 20 has been changed by the enlargement processing performed by the sharpening/enlarging unit 205. The scalers 201, 202, and 203 are controlled by a control signal 28 output by the controller 500.

If there is sufficient reserve dynamic range in the video signal level of the image data 20, which is the output video, the sharpening/enlarging unit 205 can amplify the level of the image data 20. If the sharpening/enlarging unit 205 has performed level amplification, the scalers 201, 202, and 203 cause the level change to be reflected in each of the analysis results, that is, change the levels of each of the analysis results in accordance with the level amplification. If, however, there is insufficient reserve dynamic range in the video signal level of the image data 20, which is the output video, the sharpening/enlarging unit 205 can attenuate the image data 20 to prevent level saturation. If the sharpening/enlarging unit 205 has performed level attenuation, the scalers 201, 202, and 203 cause the level change to be reflected in each of the analysis results, that is, change the levels of each of the analysis results in accordance with the level attenuation.

If it is anticipated that, by the sharpening block 200, the motion vector, the edges, or the noise detected from the image data 20, which is the output video, will change greatly from the analysis results based on the image data 10, which is the input video, the analysis results after the change by the scaler 201, 202, or 203 can be predicted and the analysis results output by the scaler 201, 202, or 203 can be changed. Alternatively, rather than in the scaler 201, 202, or 203, similar processing to change the analysis results may be performed in the adjuster 304 or the adjuster 404.

If the noise in the edge parts is emphasized by the sharpening block 200, the scaler 203 adds data indicating the noise to the noise detection result 34. Alternatively, if the noise in the edge parts is emphasized by the sharpening block 200, that is, if the deterioration of the video is emphasized, the correction amount for deterioration removal in the follower noise removal block 400 can be increased. An instruction to increase the correction amount can be made to the noise remover 405 from the adjuster 404 in the noise removal block 400, or can be made to the noise remover 405 from the controller 500.

In the shake reduction block 300, the shake reducer 305 performs image processing to remove camera shake or mechanical shake included in the image data 20, which is the input video, and outputs the image data 30, which is the output video. The shake reducer 305 receives the image data 20, which is the input video, and also receives the motion vector 32 output by the scaler 201 as the motion vector 35, via the adjuster 304. The shake reducer 305 reduces shake, so as to control sudden motion of the picture angle, in accordance with the motion vector 35. The shake reducer 305 is controlled by a control signal 37 output by the controller 500.

The adjuster 304 receives the motion vector 32 scaled by the scaler 201 and the noise detection result 34 scaled by the scaler 203. The adjuster 304 improves the accuracy of the motion vector 32 based on the noise detection result 34, so that the shake reduction result of the shake reducer 305 is further improved, and converts it to the motion vector 35. The adjuster 304, for example, based on the noise detection result 34, generates the motion vector 35 by invalidating motion vectors included in the motion vector 32 that have a relatively high level of noise among the plurality of motion vectors. If the adjuster 304 determines that the change in the analysis results such as the motion vector and noise detection result output from the analysis block 100 resulting from image processing in the previous sharpening block 200 is large, the amount of change can be predicted and prescribed correction of the motion vector 35 can be done. The adjuster 304 is controlled by a control signal 31 output by the controller 500.

The shake reducer 305 reduces shake using the adjusted motion vector 35. A general shake reduction algorithm is used. When the shake reducer 305 reduces shake, the motion vectors in the image differ in offset, size, and orientation. The shake reducer 305 moves the overall screen in the reverse direction to cancel out motion of the overall screen. When this is done, a side effect is that the edge parts, in which there is no image, might intrude. To prevent that, the shake reducer 305 can pre-enlarge the input video by approximately 1.1 times as a countermeasure to suppress intrusion of the edge parts. This has the same significance as increasing the image resolution. Therefore, if the shake reducer 305 has reduced shake, the scaler 301 scales the received motion vector 32 by the amount of the shake reduction and the enlargement of the shake reducer 305, and outputs the result as a motion vector 42. The scaler 302 scales the received edge image 33 by the amount of the shake reduction and the enlargement of the shake reducer 305 and outputs the result as an edge image 43. The scaler 303 scales the received noise detection result 34 by the amount of the shake reduction and the enlargement of the shake reducer 305 and outputs the result as a noise detection result 44. The scalers 301, 302, and 303 are controlled by a control signal 38 output by the controller 500.

The motion vector 42 output by the scaler 301 is input to the scaler 401 and the adjuster 404. The edge image 43 output by the scaler 302 is input to the scaler 402 and the adjuster 404. The noise detection result 44 output by the scaler 303 is input to the scaler 403 and the adjuster 404.

The scalers 301, 302, and 303, similar to the scalers 201, 202, and 203, can also perform level correction.

In the noise removal block 400, the noise remover 405 performs image processing to remove noise included in the image data 30, which is the input video, and outputs the image data 40, which is the output video. The noise remover 405 receives the image data 30, which is the input video, and also receives the motion vector 42 output by the scaler 301 as the motion vector 45, via the adjuster 404. The noise remover 405 also receives the edge image 43 output by the scaler 302 as the edge image 46, via the adjuster 404. The noise remover 405 further receives the noise detection result 44 output by the scaler 303 as the noise detection result 49, via the adjuster 404. The noise remover 405 removes noise by prescribed filtering processing in accordance with the motion vector 45, the edge image 46, and the noise detection result 49 and improves the image quality.

When that is done, the noise remover 405 can use the motion vector to perform time-axis filtering. The noise remover 405 can use the edge image to suppress blurring of edge parts by the filtering. The noise remover 405 can use the noise detection result 49 to determine the filtering strength and a region requiring noise reduction. The noise remover 405 is controlled by a control signal 47 output by the controller 500.

The adjuster 404 receives the motion vector 42 scaled by the scaler 301, the edge image 43 scaled by the scaler 302, and the noise detection result 44 scaled by the scaler 303. The adjuster 404 corrects other analysis results based on the other analysis results and corrects each analysis result if a prescribed image processing result is predicted, so as to improve the result of noise removal performed by the noise remover 405. The adjuster 404 is controlled by a control signal 41 output by the controller 500.

The scalers 401, 402, and 403 are constituted the same as the scalers 301, 302, and 303. The scalers 401, 402, and 403 are controlled by a control signal 48 output by the controller 500. In the example constitution shown in FIG. 1, however, because there is no further image processing anticipated with respect to the image data 40 output by the noise removal block 400. Therefore, the scalers 401, 402, and 403 can be made not to perform processing. However, it is also possible to add a processing block that performs further prescribed image processing following the noise reduction block 400. Alternatively, for example, switching can be done between the shake reduction block 300 and the noise removal block 400. In such cases, the scalers 401, 402, and 403, similar to the case of the scalers 301, 302, and 303, scale and output each of the analysis results in accordance with the image processing result of the noise remover 405.

The controller 500 performs control to manage the overall operation. The controller 500 controls the scalers 201, 202, 203, 301, and so on, so as to perform scaling in accordance with the re-sequencing of the image quality improvement blocks and the sequence of processing.

Although the foregoing description used the example of processing for sharpening, shake reduction, and noise removal, there is no restriction to these three processing steps, and application may be made as well to color correction, contrast correction, geometric transformations, and the like. In the analysis processing block, detection of humans, detection of a sky background, and the like can be done. A constitution may be adopted in which a specific region only is processed, based on the analysis results of human detection and detection of a sky background, and the like.

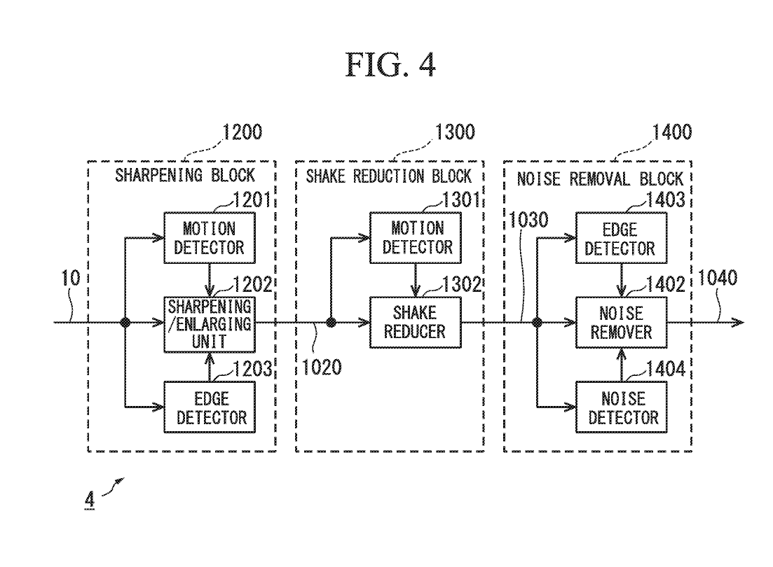

The effect exhibited by the first embodiment will now be described, making reference to FIG. 4. FIG. 4 shows an example of an image processing apparatus that performs image quality improvement processing for each of sharpening, shake reduction, and noise removal with respect to an input video. The image processing apparatus 4 shown in FIG. 4 includes a sharpening block 1200, a shake reduction block 1300, and a noise removal block 1400. The sharpening block 1200 includes a motion detector 1201, a sharpening/enlarging unit 1202, and an edge detector 1203. The shake reduction block 1300 includes a motion detector 1301 and a shake reducer 1302. The noise removal block 1400 includes a noise remover 1402, an edge detector 1403, and a noise detector 1404.

In the sharpening block 1200, the shake reduction block 1300, and the noise removal block 1400 first analyze the characteristics of the image data 10, which is the input video. That is, in the first sharpening block 1200, the motion detector 1201 detects motion and the edge detector 1203 detects edges. Next, the sharpening/enlarging unit 1202 uses the analysis result detected by the motion detector 1201, that is, uses the motion vector indicating the degree of motion of the same part between adjacent previous and subsequent frames, to perform sharpening/enlarging processing. When this is done, the sharpening/enlarging unit 1202 may use the edge detection result from the edge detector 1203 to prevent unnatural emphasis of edges.

In the second stage, the shake reduction block 1300, the shake reducer 1302 reduces shake, so as to suppress sudden motion of the picture angle, in accordance with the motion detection result from the motion detector 1301 with respect to the image data 1020. In the third stage, the noise removal block 1400, the noise remover 1402 removes noise, based on the noise detection result from the noise detector 1404 with respect to the image data 1030. When this is done, the noise remover 1402 performs noise removal filtering so that the edge parts do not blur, based on the edge detection result from the edge detector 1403.

In the image processing apparatus 4 shown in FIG. 4, between processing blocks analysis processing having a high processing load (referring to the processing by each of the detector 1201, 1203, 1301, 1403, and 1404) is performed in duplicate a plurality of times (duplication between the motion detectors 1201 and 1301 and duplication between the edge detectors 1203 and 1403). For that reason, there is a problem of a reduced system throughput. In the image processing apparatus 4, there is a problem that, if the characteristics of data are lost in a previous processing block, the accuracy of analysis processing may decrease. For example, if the edges of video are blurred in the image data 1030 of the shake reduction block 1300, the accuracy of edge detection by the edge detector 1403 of the noise removal block 1400 decreases.

In contrast, in the image processing apparatus 2 of the first embodiment described with reference to FIG. 1, because the source video is analyzed only one time in the analysis block 100, the above-noted problem can be solved. That is, according to the first embodiment, the problem of a lowering of system throughput and the problem of a lowering of the accuracy of analysis processing by loss of data characteristics in a previous processing block can be solved.

Additionally, according to the first embodiment, by scaling at each processing stage, it is easy to achieve uniformity of the input/output interface of each image quality improvement block. Achieving uniformity of input/output interfaces facilitates the addition, removal, and re-ordering of image quality improvement processing steps.

Additionally, according to the first embodiment, because the adjuster 304 or 404 (or 204) is provided, the following effect can be obtained. Specifically, by the image processing performed by the sharpening/enlarging unit 205 or shake reducer 305, the analysis result input to the adjuster 304 or the adjuster 404 (analysis result 32 or analysis result 34 or 42 to 44) does not necessarily properly represent the motion, the edges, or the noise of the input image data (input image data 20 or 30). In such a case, the adjuster 304 or the adjuster 404 can perform prescribed adjustment, which is prepared beforehand, with respect to the scaled analysis result (analysis result 32 or analysis result 34 or 42 to 44). This adjustment processing can be processing that causes the analysis result output by the adjuster 304 or the adjuster 404 (analysis result 35 or analysis result 45, 46, or analysis result 49) to approach the following described result. Specifically, the analysis result (analysis result 35 or analysis result 45, 46, or analysis result 49) can be generated by adjustment processing so that it approaches the analysis result that it is estimated that will be obtained if analysis processing is performed with respect to the input image data (input image data 20 or 30). By performing adjustment processing such as this, it can be expected that the accuracy of image processing using the analysis result output by the adjuster 304 or 404 (analysis result 35 or analysis result 45, 46, or analysis result 49) will be improved, compared to the case of not performing the adjustment processing.

Although level saturation occurs when a plurality of image quality improvement processing steps are performed in succession, the adjusters (or scalers) can make it difficult for level saturation to occur. Also, the adjusters (or scalers) can solve the problem of a lowered analysis result accuracy due to noise.

### Second Embodiment

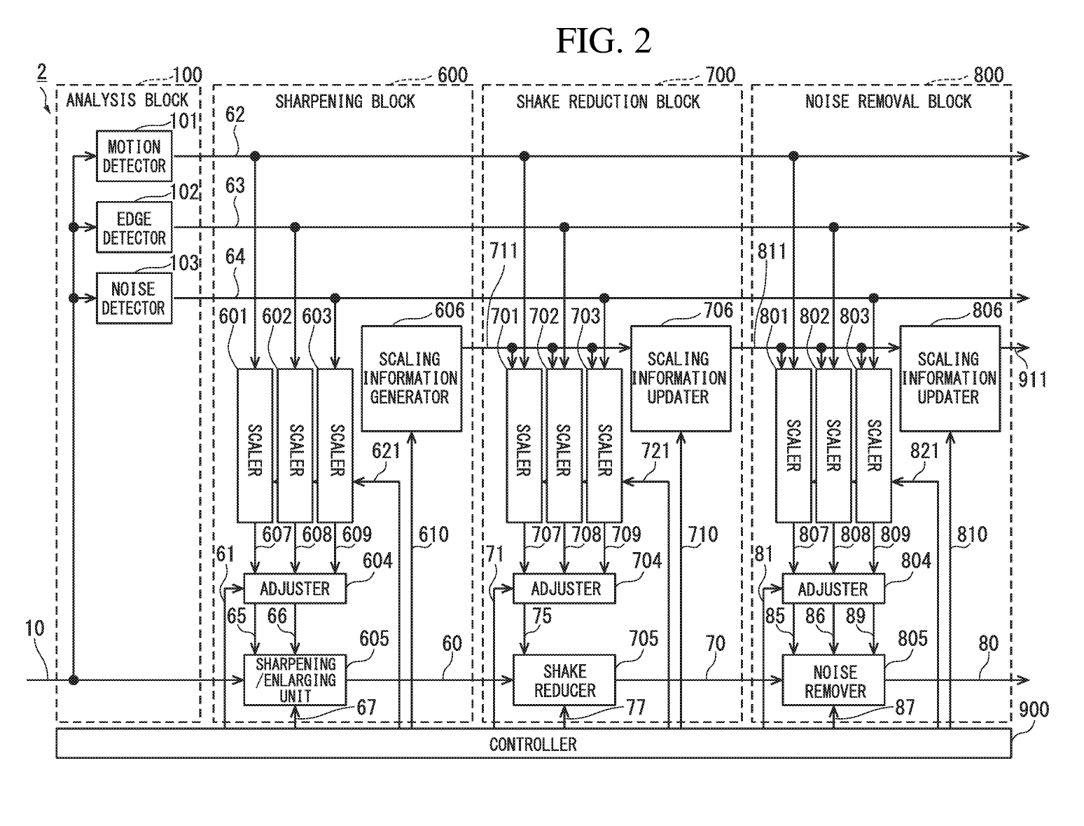

FIG. 2 is a block diagram showing the example of the constitution of an image processing system 2 of the second embodiment. The image processing system 2 shown in FIG. 2 includes an analysis block 100, a sharpening block 600, a shake reduction block 700, a noise removal block 800, and a controller 900. In FIG. 2, constituent elements that are the same as shown in FIG. 1 are assigned the same reference symbols.

The analysis block 100 has the same constitution as the analysis block 100 shown in FIG. 1 and includes a motion detector 101, an edge detector 102, and a noise detector 103. The sharpening block 600, the shake reduction block 700, and the noise removal block 800 perform image processing, which is prescribed image quality improvement processing with respect to the input video, and output processed video. The sharpening block 600 includes scalers 601, 602, and 603, an adjuster 604, a sharpening/enlarging unit 605, and a scaling information generator 606. The shake reduction block 700 includes scalers 701, 702, and 703, an adjuster 704, a shake reducer 705, and a scaling information updater 706. The noise removal block 800 includes scalers 801, 802, and 803, an adjuster 804, a noise remover 805, and a scaling information updater 806.

In the first embodiment described with reference to FIG. 1, the constitution is one in which the scalers 201 to 203, the scalers 301 to 303, and the scalers 401 to 403 further scale analysis results scaled by other scalers. In contrast, in the second embodiment shown in FIG. 2, the constitution is one in which the scalers 601 to 603, the scalers 701 to 703, and the scalers 801 to 803 scale the analysis result output from the analysis block 100, based on scaling information representing the details of the scaling by the other scalers.

In the constitution shown in FIG. 2, the motion detector 101 receives the image data 10, which is the source video, and, based on, for example, a plurality of frames of the image data 10, performs motion detection and outputs a motion vector 62 representing the result of the detection. The motion detector 101 outputs the motion vector 62 to the scaler 601, the scaler 701, and the scaler 801.

The edge detector 102 receives the image data 10, which is the source video, performs edge detection from the image data 10, and outputs an edge image 63 representing the detected result by pixel values. The edge detector 102 outputs the edge image 63 to the scaler 602, the scaler 702, and the scaler 802.

The noise detector 103 receives the image data 10, which is the source video, detects noise from the image data 10, and outputs a noise detection result 64 representing the detected result. The noise detector 103 outputs the noise detection result 64 to the scaler 603, the scaler 703, and the scaler 803.

Although FIG. 2 shows that the analysis block 100 has three types of analysis functions, the constitution within the analysis block 100 is not restricted to this combination.

In the constitution shown in FIG. 2, in the sharpening block 600, the scaler 601 outputs the received motion vector 62 as is to the adjuster 604 as the motion vector 607. The scaler 602 outputs the received edge image 63 as is to the adjuster 604 as the edge image 608. The scaler 603 outputs the received noise detection result 64 as is to the adjuster 604 as the noise detection result 609. The adjuster 604 performs prescribed adjustment processing of the received motion vector 607 in accordance with the image processing to be performed by the sharpening/enlarging unit 605 and outputs the result as a motion vector 65 to the sharpening/enlarging unit 605. The adjuster 604 performs prescribed adjustment processing of the received edge image 608 in accordance with the image processing to be performed by the sharpening/enlarging unit 605, and outputs the result to the sharpening/enlarging unit 605 as an edge image 66.

The scaling information generator 606 generates and outputs scaling information 711 in accordance with the details of image processing performed by the sharpening/enlarging unit 605. The scaling information 711 indicates what kind of scaling is required with respect to each analysis result when the various analysis results output from the analysis block 100 are used with respect to the image data 60 output by the sharpening/enlarging unit 605. The scaling information generator 606 outputs the generated scaling information 711 to the scalers 701 to 703, and the scaling information updater 706. The adjuster 604 is controlled by a control signal 61 output by the controller 900. The sharpening/enlarging unit 605 is controlled by a control signal 67 output by the controller 900. The scalers 601 to 603 are controlled by a control signal 621 output by the controller 900. The scaling information generator 606 is controlled by a control signal 610 output by the controller 900.

In the shake reduction block 700, the scaler 701 scales the motion vector 62 in accordance with the scaling information 711 output by the scaling information generator 606 and outputs the result as a motion vector 707 to the adjuster 704. The scaler 702 scales the edge image 63 in accordance with the scaling information 711 output by the scaling information generator 606 and outputs the result as an edge image 708 to the adjuster 704. The scaler 703 scales the noise detection result 64 in accordance with the scaling information 711 output by the scaling information generator 606 and outputs the result as a noise detection result 709 to the adjuster 704.

The adjuster 704 performs prescribed adjustment processing of the received motion vector 707 in accordance with the image processing to be done by the shake reducer 705, and outputs the result as a motion vector 75 to the shake reducer 705. The scaling information updater 706, in accordance with the details of the image processing that was performed by the shake reducer 705, updates the received scaling information 711 and outputs the result as scaling information 811. The scaling information 811 output by the scaling information updater 706 is information that, when the various analysis results output from the analysis block 100 are used with respect to the image data 70 output by the shake reducer 705, indicates what kind of scaling is required with respect to each analysis result. The scaling information 811 output by the scaling information updater 706 includes the details of scaling, in accordance with two types of processing, scaling in accordance with the processing by the sharpening/enlarging unit 605 and scaling in accordance with processing by the shake reducer 705.

The scaling information generator 706 outputs the updated scaling information 811 to the scalers 801 to 803 and the scaling information updater 806. The adjuster 704 is controlled by a control signal 71 output by the controller 900. The shake reducer 705 is controlled by a control signal 77 output by the controller 900. The scalers 701 to 703 are controlled by a control signal 721 output by the controller 900. The scaling information updater 706 is controlled by a control signal 710 output by the controller 900.

In the noise removal block 800, the scaler 801 scales the motion vector 62 in accordance with the scaling information 811 output by the scaling information updater 706 and outputs the result as a motion vector 807 to the adjuster 804. The scaler 802 scales the edge image 63 in accordance with the scaling information 811 output by the scaling information updater 706 and outputs the result as an edge image 808 to the adjuster 804. The scaler 803 scales the noise detection result 64 in accordance with the scaling information 811 output by the scaling information updater 706 and outputs the result as a noise detection result 809 to the adjuster 804.

The adjuster 804 performs prescribed adjustment processing with respect to the received motion vector 807 in accordance with the image processing to be performed by the noise remover 805, and outputs the result as a motion vector 85 to the noise remover 805. The adjuster 804 performs prescribed adjustment processing with respect to the received edge image 808 in accordance with the image processing to be performed by the noise remover 805 and outputs the result as an edge image 86 to the noise remover 805. The adjuster 804 performs prescribed adjustment processing with respect to the received noise detection result 809 in accordance with the image processing to be performed by the noise remover 805 and outputs the result as a noise detection result 89 to the noise remover 805.

The scaling information updater 806, in accordance with the details of the image processing performed by the noise remover 805, updates the received scaling information 811 and outputs the result as a scaling information 911. The scaling information 911 output by the scaling information updater 806 indicates what kind of scaling is required with respect to each analysis result when the various analysis results output from the analysis block 100 are used with respect to the image data 80 output by the noise remover 805. The scaling information 911 output by the scaling information updater 806 includes scaling in accordance with the three processing steps, that is, scaling in accordance with processing by the sharpening/enlarging unit 605, scaling in accordance with the processing by the shake reducer 705, and scaling in accordance with the processing by the noise remover 805. However, if there is no processing block following the noise removal block 800, the updating processing of the scaling information 911 by the scaling information updater 806 can be omitted.

The adjuster 804 is controlled by a control signal 81 output by the controller 900. The noise remover 805 is controlled by a control signal 87 output by the controller 900. The scalers 801 to 803 are controlled by a control signal 821 output by the controller 900. The scaling information updater 806 is controlled by a control signal 810 output by the controller 900.

The sharpening/enlarging unit 605, the shake reducer 705, and the noise remover 805 in the second embodiment may be constituted to perform the same processing as the sharpening/enlarging unit 205, the shake reducer 305, and the noise remover 405 in the first embodiment. The adjusters 604, 704, and 804 in the second embodiment may be constituted to perform the same processing as the adjusters 204, 304, and 404 in the first embodiment.

In the second embodiment, rather than scaling being done in each of the image quality improvement blocks from the sharpening block 600 to the noise removal block 800, scaling information is generated and updated each time as processing is performed. The operation of the analysis block 100 is the same as that of the analysis block 100 in FIG. 1.

In the sharpening block 600, only the scaling operation differs from the first embodiment. Because this block performs the first processing, the scaling information generator 606 generates the scaling information 711. Because the sharpening/enlargement by the sharpening/enlarging unit 605 changes the resolution, the scaling information generator 606 generates scaling information 711 of a resolution multiplier. The scaling information 711 indicates how each of the analysis results (62, 63, and 64) output from the analysis block 100 should be scaled, and the actual analysis results are not changed in the scaling information generator 606.

The scaling information generator 606 can be made the scaling information updater. That is, in order to use a common interface for the image quality improvement blocks, a constitution may be adopted in which, for example, in the analysis block 100, unchanged scaling information (that scaling is not to be done) may be generated and input to the sharpening block 600.

If there is sufficient reserve dynamic range in the video signal level of the image data 60, which is the output video of the sharpening/enlarging unit 605, the sharpening/enlarging unit 605 can amplify the level of the video signal. In this case, the scaling information generator 606 causes the change of the video signal level to be reflected in the scaling information 711. If, however, there is insufficient reserve dynamic range in the image data 60, the sharpening/enlarging unit 605 can attenuate the level of the video signal, to prevent level saturation. In this case, the scaling information generator 606 causes the scaling information 711 to reflect the video signal level change.

In the shake reduction block 700, the scaling information 711 is input to the scalers 701 to 703. For example, the scaler 701 scales the motion vector 62 by the scaling information 711 and outputs the result as a motion vector 707. The scaler 703 scales the noise detection result 64 by the scaling information 711 and outputs the result as a noise detection result 709. Next, the adjuster 704 improves the accuracy of the motion vector 707 based on the noise detection result 709 and outputs the result as a motion vector 75. The shake reducer 705 uses the motion vector 75 adjusted by the adjuster 704 to perform shake reduction processing. If the resolution has been expanded to 1.1 times at the time of shake reduction by the shake reducer 705, the resolution multiplier scaling information is updated by the scaling information updater 706. The processing to prevent level saturation is the same as in the sharpening block 600.

In the noise removal block 800, image quality is improved by using the motion vector 62, the edge image 63, and the noise detection result 64 analysis results. If the result of removing random noise and grain noise is that the noise level has decreased, the scaling information updater 806 updates the scaling information so as to reflect the noise level change. That is, the scaling information updater 806 updates the scaling information so that it indicates that the noise level indicated by the noise detection result 64 has changed by processing by the noise remover 805, and outputs the result as scaling information 911. Alternatively, if processing by the noise remover 805 has reduced local noise such as scratch, line, pulse, or dust noise, the scaling information updater 806 generates scaling information that invalidates the noise detection result at those positions.

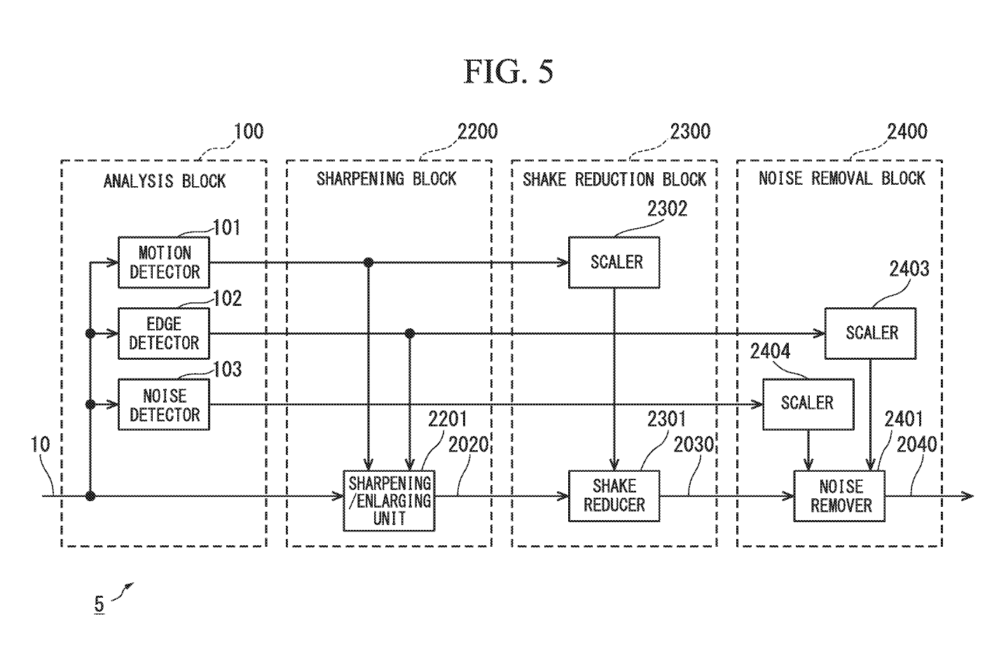

The effect exhibited by the second embodiment will now be described, making reference to FIG. 5. FIG. 5 shows an example of an image processing apparatus that performs the image quality improvement processing of sharpening, shake reduction, and noise removal with respect to the input signal. The image processing apparatus 5 shown in FIG. 5 includes an analysis block 100, a sharpening lock 2200, a shake reduction block 2300, and a noise removal block 2400. The analysis block 100 is constituted the same as the analysis block 100 shown in FIG. 2. The sharpening block 2200 includes a sharpening/enlarging unit 2201. The shake reduction block 2300 includes a shake reducer 2301 and a scaler 2302. The noise removal block 2400 includes a noise remover 2401, a scaler 2403, and a scaler 2404. The image processing apparatus 5 receives an image data 10, which is the source video, performs image processing of sharpening, shake reduction, and noise removal, and outputs image data 2040 as the result of the processing.

In the image processing apparatus 5 shown in FIG. 5, in the analysis block 100, motion detection by the motion detector 101, edge detection by the edge detector 102, and noise detection by the noise detector 103 are perform only one time with respect to the image data 10, which is the source video. The operation of the sharpening/enlarging block 2200 is the same as that of the sharpening/enlarging block 1200 described with reference made to FIG. 4. In the shake reduction block 2300, the scaler 2302 scales the analysis result output by the motion detector 101 in accordance with the details of the processing by the sharpening/enlarging unit 2201. For example, if the resolution of the video of the image data 10 changed by enlargement in the sharpening block 2200, the scaler 2302 scales the motion vector output by the motion detector 101 accordingly.

Similarly, the noise removal block 2400, after the scaler 2403 scales the edge detection result output by the edge detector 102, uses this in noise removal by the noise remover 2401. After the scaler 2404 scales the noise detection result output by the noise detector 103, it is used in the noise removal by the noise remover 2401.

In the image processing apparatus 5 shown in FIG. 5, scalers are provided in each processing block as necessary. For that reason, because interchanging of processing sequence is difficult (because scaling is required in accordance with previous processing), accommodation in the case in which it is better to analysis the input video (for example, 2020 or 2030) of the processing block sometime cannot be done.

In contrast, in the image processing system 2 of the second embodiment shown in FIG. 2, by performing scaling at each processing, it is easy to achieve commonality among the input/output interfaces of each image quality improvement block. By having commonality among the input/output interfaces, it is easy to add, remove, or re-order the image quality improvement processing steps.

Additionally, according to the second embodiment, the following effect is achieved by providing the adjuster 704 or 804 (or 604). Specifically, the adjuster 704 or 804 performs adjustment processing so that the analysis result output by the adjuster 704 or 804 (analysis result 75 or 85 or analysis result 86 or 89) is made to approach the analysis result predicted to be obtained if the input video (image data 60 or 70) at each processing block is analyzed. According to this adjustment processing, compared to case of not performing adjustment processing, can be expected to yield a better image processing result.

Although level saturation occurs in the course of processing when a plurality of image quality improvement processing steps are performed in succession, the adjusters (or scalers) can make it difficult for level saturation to occur. Also, the adjusters (or scalers) can solve the problem of a lowered analysis result accuracy due to noise.

### Third Embodiment

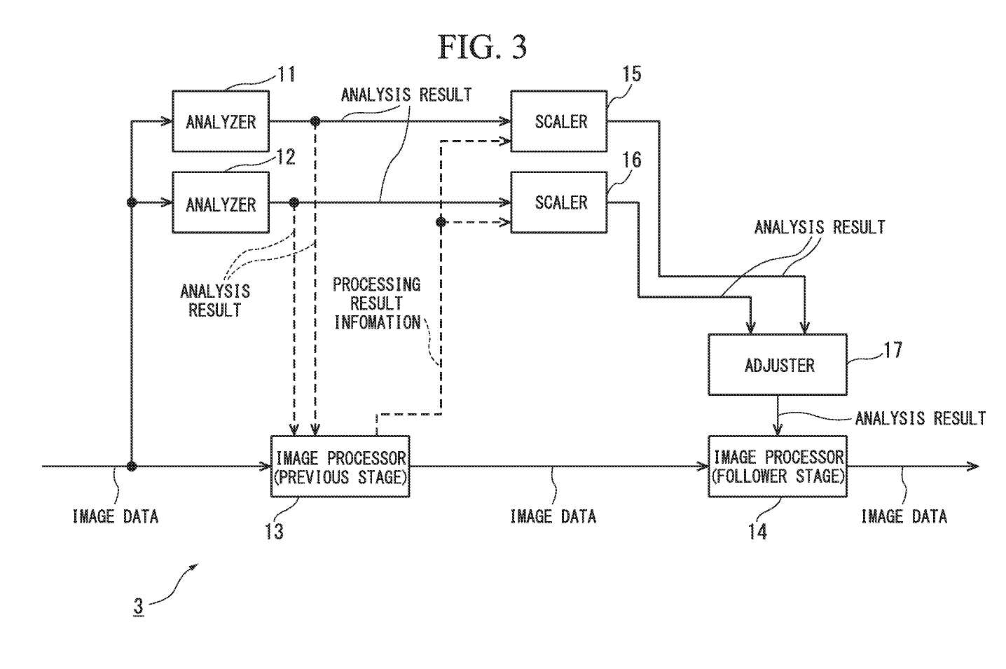

FIG. 3 is a block diagram showing an image processing system 3 of the third embodiment. The image processing system 3 shown in FIG. 3 includes analyzer 11 (first analyzer, second analyzer), an analyzer 12 (first analyzer, second analyzer), an image processor 13 (first image processor), an image processor 14 (second image processor), a scaler 15 (first scaler, second scaler), a scaler 16 (first scaler, second scaler), and an adjuster 17. The image processing system 3, for example, can be constituted by a processor such as an image processing DSP or a general-purpose CPU and a program executed by the processor, an image processing ASIC, an FPGA, and an image processing IP core or the like. Each block shown in FIG. 3, for example, can be constituted as one module.

The third embodiment shown in FIG. 3 is constituted to have constituent elements of a generic concept that each encompasses a constituent element falling under the same concept as in the above-described first embodiment and second embodiment. That is, the analyzer 11 or 12 shown in FIG. 3 corresponds to the motion detector 101, the edge detector 102, and the noise detector 103 shown in FIG. 1. The image processor 13 shown in FIG. 3 corresponds to the sharpening/enlarging unit 205 shown in FIG. 1. The image processor 14 shown in FIG. 3 corresponds to the shake reducer 305 shown in FIG. 1. The scaler 15 or 16 shown in FIG. 3 corresponds to the scalers 201, 202, and 203 shown in FIG. 1. The adjuster 17 shown in FIG. 3 corresponds to the adjuster 304 shown in FIG. 1. The image processing 13 shown in FIG. 3 may be the constituent element corresponding to the shake reducer 305 shown in FIG. 1. In this case, the image processor 14 shown in FIG. 3 is the constituent element corresponding to the noise remover 405 shown in FIG. 1. The scaler 15 or 16 shown in FIG. 3 is the constituent element corresponding to the scalers 301, 302, and 303 shown in FIG. 1. The adjuster 17 shown in FIG. 3 is the constituent element corresponding to the adjuster 404 shown in FIG. 1.

Regarding the constituent elements shown in FIG. 2, the motion detector 101, the edge detector 102, and the noise remover 103 are constituent elements corresponding to the analyzer 11 or 12 shown in FIG. 3. The sharpening/enlarging unit 605 is the constituent element corresponding to the image processor 13 shown in FIG. 3. The shake reducer 705 is the constituent element corresponding to the image processor 14 shown in FIG. 3. The scalers 701, 702, and 703 are constituent elements corresponding to the scaler 15 or 16 shown in FIG. 3. The adjuster 704 is the constituent element corresponding to the adjuster 17 shown in FIG. 3. The shake reducer 705 may be the constituent element corresponding to the image processor 13 shown in FIG. 3. In this case, the noise remover 805 is the constituent element corresponding to the image processor 14 shown in FIG. 3. The scalers 801, 802, and 803 are constituent elements corresponding to the scaler 15 or 16 shown in FIG. 3. The adjuster 804 is the constituent element corresponding to the adjuster 17 shown in FIG. 3.

Each of the plurality of analyzers 11 and 12 analyzes the received image data and outputs the prescribed processed result. The prescribed processed result is a result that has detected a prescribed characteristic included in the image data and can be, for example, the result of motion detection, edge detection, or noise detection. The analysis result, for example, can be a representation of the detected characteristic as a value indicating the size, direction and size of a change, or the size of a change of a pixel value or the detected position.

The image processor 13 performs prescribed image processing with respect to the received image data, in accordance with an analysis result output by the analyzer 11 and/or the analyzer 12 and outputs the processed image data. The image processor 14 performs prescribed image processing with respect to the received image data, in accordance with the analysis result output by the analyzer 11 and/or the analyzer 12, and outputs the processed image data. The image processing performed by the image processor 13 and the image processor 14 can be, for example, processing for improvement of the image quality of a deteriorated image, such as sharpening and enlargement, shake reduction, and noise removal. However, the details of the image processing are not restricted to this.

In the example shown in FIG. 3, the image processor 14 receives the analysis results output by the analyzers 11 and 12 via the scalers 15 and 16. If the image processor 13 is a previous image processor, the image processor 14, as a follower image processor, receives the image data (that is, which has be processing by the previous image processor 13) output by the previous image processor 13.

The scalers 15 and 16 scale the analysis results to be used by the follower image processor 14 in accordance with the result of image processing performed by the previous image processor 13. In the present embodiment, scaling refers to the performing of prescribed change processing with respect to an input analysis result and outputting the processed analysis result. Prescribed change processing means processing to change an analysis result in a prescribed case. A prescribed case is the case in which it is not appropriate to use the analysis results output by the analyzers 11 and 12 by the image processing by the previous image processor 13 as is with respect to the image data received by the follower image processor 14. Processing to change an analysis result means processing to change an analysis result value to a value that is appropriate with respect to image data to be received by the follower image processor 14. For example, the scalers 15 and 16 determine whether the analysis result is usable with respect to the image data to be used by the follower image processor 14 after the previous image processor 13 performs the image processing. The scalers 15 and 16 scale the analysis result to be used by the follower image processor 14 when the analysis result is not usable with respect to the image data to be used by the follower image processor 14. The scalers 15 and 16 may output an analysis result with respect to which prescribed change processing has been performed, or may output information for the prescribed change processing with respect to the yet-to-be-changed analysis result. The scalers 15 and 16 can receive information indicating the image processing results from the image processor 13, either directly from the image processor 13, or via a prescribed controller not illustrated.

The attribute of analysis results to be changed by the scalers 15 and 16 may be, for example, resolution, the video signal level, the motion vector offset, or the noise position or size. For example, if the analysis result represents the position, direction, or size of a prescribed characteristic, using pixel coordinates or the number of pixels, when the previous image processor 13 performs image processing to change the resolution of image data, the scalers 15 and 16 perform change processing with respect to the coordinates and number of pixels included in the analysis result, in accordance with the change in the resolution. Alternatively, if an image processor has performed image processing such as that which changes the dynamic range of pixel values, the scalers 15 and 16 perform change processing with respect to the pixel values included in the analysis results, in accordance with change in the dynamic range. Alternatively, if the analysis result is a noise detection result, when, for example, image processing has been performed so as to remove noise, the scalers 15 and 16 can perform change processing with respect to the analysis result, so as to lower the noise level indicated by the analysis result. Alternatively, if the analysis result is a noise detection result, when image processing has been performed to remove noise, the scalers 15 and 16 can perform change processing with respect to the analysis results so as to remove the noise detection information. Alternatively, for example, if the analysis result is a motion vector analysis result, when image processing has been performed to reduce shake, the scalers 15 and 16 can perform change processing with respect to the analysis result so as to decrease the size of the motion vector indicated by the analysis result. Alternatively, if the analysis result is a motion vector analysis result, when image processing has been performed so as to reduce shake, the scalers 15 and 16 can perform change processing with respect to the analysis result so as to delete the motion vector detection information.

The adjuster 17 receives the analysis result scaled by the scaler 15 and the analysis result scaled by the scaler 16. However, the adjuster 17 may receive either one of the analysis result scaled by the scaler 15 and the analysis result scaled by the scaler 16. The scaler 17 performs prescribed adjustment processing with respect to at least one of the received analysis results, in accordance with the image processing to be performed by the image processor 14, and outputs it to the image processer 14.

By the image processing performed by the previous image processor 13, if a new change in the image quality occurs that was not detected by the analyzer 11 or 12, and the analysis result does not reflect that change, the adjuster 17 can change the analysis result, for example, as follows. Specifically, for example, after image processing by the previous image processor 13, if it is predicted that the image processing by the follower image processor 14 will be affected unless the analysis result is changed, a change can be made to the analysis result to suppress the predicted effect. That is, if it is predicted that the image processing by the follower image processor 14 will be affected by the image processing by the previous image processor 13, the adjuster 17 can perform adjustment processing to cause the prediction to be reflected in the analysis results. Stated differently, the adjuster 17 can perform correction of the analysis result to be used by the follower image processor 14, in accordance with the change to the image data input by the follower image processor 14 predicted based on the result of image processing performed by the previous image processor 13.

One example of a case in which it is predicted that if the adjuster 17 inputs the analysis results output from the scalers 15 and 16 as is to the image processor 14 and the image processor 14 performs prescribed image processing based on those results, the processing results will not be appropriate, is as follows. Specifically, when it is predicted that, if the analysis results are not changed, level saturation will occur in the image data by the image processing by the image processor 14, adjustment processing can be done to change the analysis results, so that level saturation does not occur. That is, the adjuster 17 can perform adjustment to prevent video level saturation with respect to the analysis results.

The adjuster 17 can also, for example, adjust the contents of other received analysis results based on one received analysis result, and adjust the content of analysis results based on information obtained when image data was captured. This adjustment can increase the accuracy of the image processing by the follower image processor 14. For example, if detection has been made that the noise had been high in one region within the image data, based on one analysis result, the adjuster 17 invalidates the result of edge detection or the result of motion vector detection of that region, or can perform adjustment processing to set added information indicating that the reliability of the analysis result is low. That is, if at least one of the analyzer 11 or 12 performs analysis processing to detect prescribed noise from the image data, the adjuster 17 can perform adjustment processing to correct the effect of the noise with respect to another analysis result, based on the noise detection information.

The image processor 14, in accordance with the analysis result that is scaled as described above by the scaler 15 or 16 and further subjected to adjustment processing by the adjuster 17, performs prescribed image processing with respect to the image data output from the previous image processor 13 and outputs the processed image data.

According to the image processing system 3 of the third embodiment described with reference made to FIG. 3, by providing the scalers 15 and 16, it is possible to share the same analyzer 11 and analyzer 12 between the image processor 13 and the image processor 14. It is therefore possible to improve the throughput by this commonality of analysis processing. Also, because the analyzer 11 and the analyzer 12 can perform image processing of the source video (that is, the video before image processing), the analysis accuracy can be improved.

For example, if further prescribed image processing is to be performed with respect to the image data output by the image processor 14, a set of elements that are the same as the scalers 15 and 16, the adjuster 17, and the image processor 14 can be added and used. That is, by adding constituent elements that are the same as the scalers 15 and 16, the adjuster 17, and the image processor 14 with respect to the output of the image processor 14, it is possible to add new image processing without adding an analyzer. In this case, it is easy to have a common input/output interface of the image data and analysis results. Therefore, the addition, removal, and re-ordering of a plurality of image processing steps can be done flexibly and easily.

The above-described first to the third embodiments can be widely used, for example, with video on analog video tape or film that has deteriorated with aging, monitoring camera video captured under poor conditions, post-production for broadcasting, medical testing video that includes a large amount of noise, and video that is mixed with noise from radiation.

The processing platform when building the first to the third embodiments can be as follows. Specifically, in recent years, because of an increase in hardware capable of a plurality of processing types, an image quality improvement block can be assigned to a plurality of processing units, it easy to achieve a constitution in which analysis processing of the source video is performed only one time, and a plurality of subsequent image quality improvement blocks are operated in pipeline fashion. Even in a cloud-based platform, in which processing nodes are linked via a network, by sharing analysis information and modularizing each image quality improvement block, it is possible to achieve high throughput and a flexible configuration. Also, the first to the third embodiments, in addition to a constitution using a processor such as an image processing DSP or a general-purpose CPU and a program executed by the processor, can be implemented by dedicated circuitry of an LSI (large-scale integration) device, such as an image processing ASIC, FPGA, and an image processing IP core, or a combination thereof.

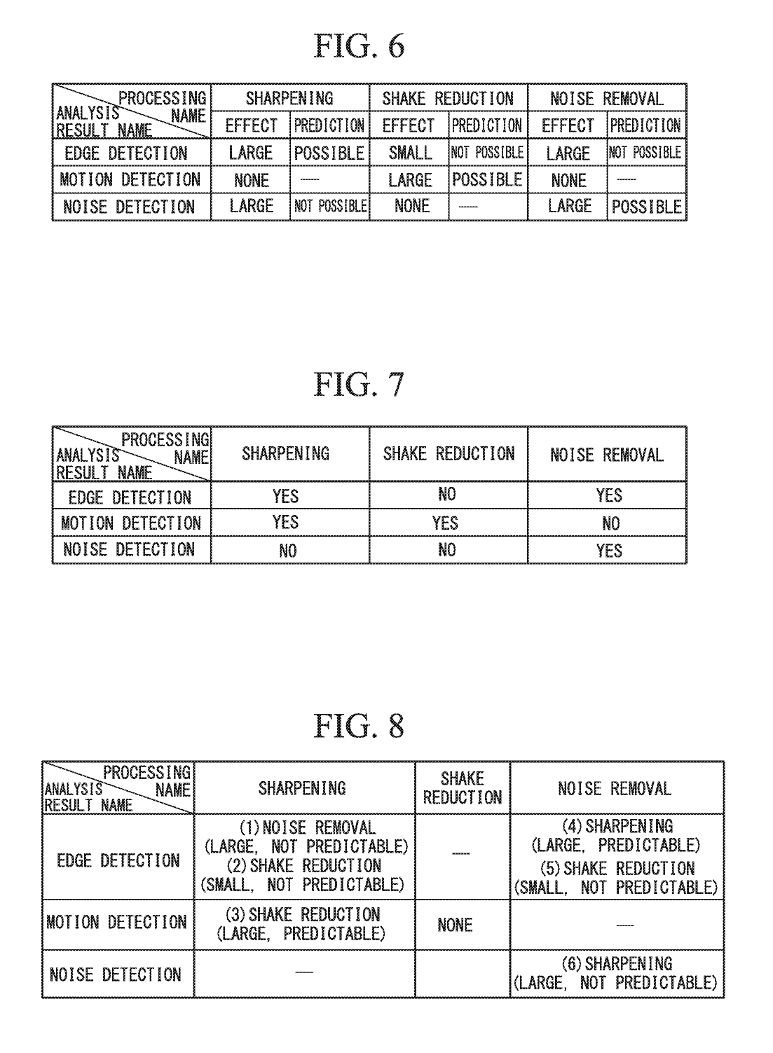

A variation example of the above-noted embodiments will now be described, with references made to FIG. 6 to FIG. 8. FIG. 6 shows the effect of each processing on the analysis results and whether or not that effect is predictable. As shown in FIG. 6, the sharpening processing has a large effect on the edge detection results. However, this effect is predictable. In contrast, it does not affect the motion detection results. It has a large effect on the noise detection result and is also unpredictable. Being predictable means the case in which, in each processing step (that is, at each image processor) there is an intentional change made. Also, being unpredictable means the case in which an unintentional change occurs accompanying processing.

Shake reduction processing has a small effect on the edge detection result. This effect is unpredictable. In contrast, the motion detection result is greatly affected, and also this effect is predictable. The noise detection result is not affected. Noise removal processing greatly affects the edge detection result and also the effect is unpredictable. In contrast, the motion detection result is not affected. The noise detection result is greatly affected, although this is predictable.

Next, the analysis results generally used in each processing step will be described, with reference made to FIG. 7. FIG. 7 provides a summary of the analysis results generally used in each processing step. As shown in FIG. 7, sharpening processing uses the edge detection result and the motion detection result. Shake reduction processing uses the motion detection result. Noise removal processing uses the edge detection result and the noise detection result.

Next, referring to FIG. 8, the previous processing by which each processing step is affected will be described. FIG. 8 shows a summary of the extent of the effect and the predictability of the previous processing that affects each processing step. For example, as shown in FIG. 7, sharpening processing uses the edge detection result and the motion detection result, and when noise removal processing is done before the sharpening processing, the edge detection result is greatly affected by the noise removal processing, and is unpredictable (case (1)). If shake reduction processing is done before sharpening processing, the edge detection result is slightly affected by the shake reduction processing and is unpredictable (case (2)). If shake reduction processing is done before sharpening processing, the motion detection result is greatly affected by the shake reduction processing and is predictable (case (3)).

The noise removal processing uses the edge detection result and the noise detection result, and if sharpening processing is done before the noise removal processing, the edge detection result is greatly affected by the sharpening processing and is predictable (case (4)). If the shake reduction processing is done before the noise removal processing, the edge detection result is slightly affected by the shake reduction processing and is not predictable (case (5)). If sharpening processing is done before the noise removal processing, the noise removal result is greatly affected by the sharpening processing and is not predictable (case (6)).

In FIG. 8, with regard to those parts for which the effect on the analysis results is predictable, by using a scaler to change the analysis result, the effect of previous processing can be eliminated. In contrast, with regard to those parts for which the effect on the analysis results is not predictable, correction by a scaler is difficult. In this case, by providing the following function in the adjuster, the effects of previous processing (which in this case is not restricted to being the immediately previous stage, but includes two or more stages previous) on analysis results that are not predictable can be eliminated. A constitution handles cases (1) and (6), which are unpredictable and which have a large effect will now be described. Case (1) is the case of edge detection processing when noise removal processing is done before sharpening processing. That is, edges when noise removal processing has been done might greatly differ from edges detected with respect to the source video. In this case, therefore, rather than using the edge detection results with respect to the source video, it is better to use the result of once again performing edge detection of the video input to the sharpening processing step, that is, to the sharpening block. Given this, as a variation example of the above-noted embodiments, a judgment unit that first determines whether or not noise removal processing has been performed in previous processing is provided within either the sharpening block or the controller. Then, if the judgment unit determines that noise removal processing had has been done in previous processing, processing to perform edge detection is executed with respect to the input video of the sharpening block. Using the edge detection result with respect to the input video, additional sharpening processing is executed in the sharpening/enlarging unit. In the same manner, in case (6) as well, that is, in the case of noise detection processing when there is sharpening processing before the noise removal processing, the noise removal block is modified as follows. Specifically, a judgment unit that first determines whether or not sharpening processing has been performed in previous processing is provided within either the noise removal block or the controller. Then, if the judgment unit determines that sharpening processing had been done in previous processing, additional processing is executed to perform noise detection with respect to the input video of the noise removal block. Using the noise removal result with respect to the input video, noise removal processing is executed in the noise remover. By adding this type of processing, a large unpredictable effect on the analysis result can be eliminated.

In the description of the above-noted first embodiment, the case described is that in which, if the video deterioration has been emphasized by previous processing, it is possible to increase the correction amount for deterioration removal in follower image processing, a specific example thereof being (4) in FIG. 8, which the effect is large and predictable. That is, the noise correction amount can be increased if there is sharpening processing before the noise removal processing. In this case, edges that were excessively emphasized in sharpening can be corrected by smoothing in noise removal. Because case (3) in FIG. 8 does not correspond to deterioration, it can be handled by scaling.

According to at least one of the above-described embodiments, by including a scaler in each image processor, scaling is done of the analysis results used by follower image processors performing image processing such as sharpening, shake reduction, noise removal and the like, in accordance with the results of image processing performed by a previous image processor. An adjuster receives one or more analysis results scaled by the scaler, performs prescribed adjustment processing of at least one analysis result, in accordance with image processing to be performed by a follower image processor, and outputs the result to an image processor. It is easy, therefore, to share analyzers, or to change the sequence of the combination of image processing steps. Thus, it is possible to achieve an efficient constitution if a plurality of image processing steps are performed in combination.

The image processing system of the above-described embodiments may include, but is not limited to: one or more software components; and one or more hardware processors that are, when executing one or more software components, configured to implement each function of the image processing system. Alternatively, each function of the image processing system may be implemented by circuitry.

The term “hardware processor” may be implemented by one or more hardware components. The hardware processor is configured to execute one or more software components and configured, when executing the one or more software components, to perform one or more acts or operations in accordance with codes or instructions included in the one or more software components.

The term “circuitry” refers to a system of circuits which is configured to perform one or more acts or operations. The term “circuitry” is implemented by hardware and software components.

The expression “computer-readable recording medium” refers to a removable medium such as a flexible disk, an opto-magnetic disk, a ROM (read only memory), or a CD-ROM, or to a storage device built into a computer, such as a hard-disk.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An image processing system comprising:
a first analyzer configured to analyze image data to generate an analysis result;
an image processor configured to perform image processing of the image data in accordance with the analysis result, to generate processed image data, the image processor comprising a first image processor and a second image processor, the second image processor being configured to receive an output from the first image processor; and
a first scaler configured to determine whether the analysis result is usable with respect to the image data to be used by the second image processor after the first image processor performs the image processing, and to scale the analysis result to be used by the second image processor when the analysis result is not usable with respect to the image data to be used by the second image processor.

2. The image processing system according to claim 1, further comprising:
an adjuster configured to adjust the analysis result scaled by the first scaler in accordance with image processing to be performed by the second image processor, and to input the adjusted analysis result into the second image processor.

3. The image processing system according to claim 1,
wherein the attribute of the analysis result scaled by the first scaler includes at least one of resolution, image signal level, motion vector offset, and position or characteristics of noise.

4. The image processing system according to claim 1, further comprising:
a second scaler configured to further scale the analysis result scaled by the first scaler.

5. The image processing system according to claim 1, further comprising:
a second scaler configured to scale the analysis result output from the first analyzer, based on scaling information representing the details of the scaling by the first scaler.

6. The image processing system according to claim 2,
wherein the adjuster is configured to prevent image level saturation with respect to the analysis result.

7. The image processing system according to claim 2, further comprising:
a second analyzer,
wherein the first analyzer is configured to detect a noise from the image data, and
the adjuster is configured to correct the effect by noise of analysis result of the second analyzer based on the noise detection information from the first analyzer.

8. The image processing system according to claim 2,
wherein the adjuster is configured to correct the analysis result to be used by the second image processer, in accordance with a change of the image data to be received by the second image processer, and the change of the image data is predicted based on the result of image processing performed by the first image processer.

9. The image processing system according to claim 2,
wherein the adjuster is configured to correct the analysis result based on information obtained at the time of capturing the image data.

10. The image processing system according to claim 2,
wherein the adjuster is configured to increase the correction amount for deterioration removal by the second image processor when the deterioration of the video is emphasized in the image processing performed by the first image processor.

11. The image processing system according to claim 1,
wherein the first scaler is configured to change coordinates and number of pixels included in the analysis result in accordance with a change in resolution when the first image processor performs the image processing to change resolution of the image data.

12. The image processing system according to claim 1,
wherein the first scaler is configured to lower noise level indicated by the analysis result or to remove noise detection information when the first image processor performs the image processing to remove noise of the image data.

13. The image processing system according to claim 1,
wherein the first scaler is configured to decrease a size of motion vector indicated by the analysis result or to delete motion vector detection information when the first image processor performs the image processing to reduce shake of the image data.

14. An image processing method comprising:
analyzing image data to generate an analysis result;
performing image processing of the image data in accordance with the analysis result, to generate processed image data, the image processing comprising a first image processing step and a second image processing step, an output in the first image processing step being used in the second image processing step; and
determining whether the analysis result is usable with respect to the image data to be used in the second image processing step after the first image processing step, and scaling the analysis result to be used in the second image processing step if the analysis result is not usable with respect to the image data to be used in the second image processing step.

15. The image processing method according to claim 14, further comprising:
adjusting the scaled analysis result in accordance with the image processing to be performed in the second image processing step,
wherein the adjusted analysis result is used in the second image processing step.

16. A non-transitory computer-readable recording medium storing an image processing program for causing a computer to execute:
analyzing image data to generate an analysis result;
performing image processing of the image data in accordance with the analysis result, to generate processed image data, the image processing comprising a first image processing step and a second image processing step, an output in the first image processing step being used in the second image processing step; and
determining whether the analysis result is usable with respect to the image data to be used in the second image processing step after the first image processing step, and scaling the analysis result to be used in the second image processing step if the analysis result is not usable with respect to the image data to be used in the second image processing step.

17. The recording medium according to claim 16,
wherein the image processing program further causes the computer to execute:
adjusting the scaled analysis result in accordance with the image processing to be performed in the second image processing step,
wherein the adjusted analysis result is used in the second image processing step.
